(19) United States
(12) Patent Application Publication
(10) Pub. No.: US 2017/0048552 A1
(43) Pub. Date: Feb. 16, 2017

(54) METHOD AND APPARATUS FOR DETERMINING RESIDUE TRANSFORM TREE REPRESENTATION

(71) Applicants: Jicheng AN, Beijing City (CN); Kai ZHANG, Beijing (CN); Jing YE, San Jose, CA (US); Shan LIU, San Jose, CA (US)

(72) Inventors: Jicheng AN, Beijing City (CN); Kai ZHANG, Beijing (CN); Jing YE, San Jose, CA (US); Shan LIU, San Jose, CA (US)

(21) Appl. No.: 15/305,834

(22) PCT Filed: May 5, 2015
(86) PCT No.: PCT/CN2015/078270

§ 371 Date: Oct. 21, 2016

Related U.S. Application Data
(63) Continuation-in-part of application No. PCT/CN2014/086426, filed on Sep. 12, 2014.
(60) Provisional application No. 61/988,403, filed on May 5, 2014.

(51) Int. Cl. H04N 19/60; H04N 19/46; H04N 19/96

(52) U.S. Cl. CPC H04N 19/60; H04N 19/96; H04N 19/46; H04N 19/186

(57) ABSTRACT

A method and associated apparatus for determining residue transform tree for color components in a video sequence are provided. The method includes the steps of: determining an individual transform depth increase for each color component; and determining a transform tree for each color component according to the individual transform depth increase associated with each color components.

### CROSS REFERENCE TO RELATED APPLICATIONS

This application claims the benefit of U.S. Provisional Application No. 61/988,403, filed at May 5, 2014, and PCT application No. PCT/CN2014/086426, filed at Sep. 12, 2014, the entirety of which are incorporated by reference herein.

### TECHNICAL FIELD

The present invention relates to video coding, and, in particular, to methods and apparatuses for residue transform depth representation for Y, U, and V components in High Efficiency Video Coding (HEVC).

### BACKGROUND

HEVC is an advanced video coding system developed under the Joint Collaborative Team on Video Coding (JCT-VC) group of video coding experts from ITU-T Study Group. In HEVC, the residue transform depth is shared between luma (Y) and chroma (U and V) components. FIG. 1 is a diagram illustrating the transform unit (TU) split in HEVC. In transform tree syntax, a syntax element split_transform_flag is used to indicate the transform depth increase for all Y, U, and V components as shown in FIG. 1.

FIG. 2 is a flow chart illustrating the coding of TU split flag and coded block flag (cbf) flag in HEVC. In Sequence Parameter Set RBSP (SPS) syntax, a syntax element max_transform_hierarchy_depth_inter is used to indicate the maximum transform depth in a sequence for all Y, U, and V components for inter case, and a syntax element max_transform_hierarchy_depth_intra is used to indicate the maximum transform depth in a sequence for all Y, U, and V components for intra case.

However, there is no evidence to show that the Y, U, and V components have dependencies in residue transform depth. Therefore, applying the same transform depth on Y, U, and V components may hurt coding performance.

### SUMMARY

In light of the previously described problems, there exists a need for an apparatus and method, in which the different color components are not forced to have the same residual transform depth.

A method for determining residue transform trees for color components in video coding is provided. The method includes the steps of: determining an individual transform depth increase for each color component; and determining a transform tree for each color component according to the individual transform depth increase associated with each color component.

An apparatus for determining residue transform trees for color components in video coding is provided. The apparatus includes: one or more computer processors; and a non-transitory computer-readable storage medium comprising instructions that, when executed by the one or more computer processors, controls the one or more computer processors to be configured for: determining an individual transform depth increase for each color component; and determining a transform tree for each color component according to the individual transform depth increase associated with each color component.

### BRIEF DESCRIPTION OF DRAWINGS

The present invention can be more fully understood by reading the subsequent detailed description and examples with references made to the accompanying drawings, wherein:

FIG. 1 is a diagram illustrating the TU split in HEVC;

FIG. 2 is a flow chart illustrating the coding of TU split flag and cbf flag in HEVC;

FIG. 3 is a diagram illustrating separate split transform flags for the color components Y, U, and V in accordance with an embodiment of the invention;

FIG. 4A is a flow chart of splitting the residue transform tree for the Y component in accordance with an embodiment of the invention;

FIG. 4B is a flow chart of splitting the residue transform tree for the U component in accordance with an embodiment of the invention;

FIG. 4C is a flow chart of splitting the residue transform tree for the V component in accordance with an embodiment of the invention;

FIG. 5 is a diagram illustrating separate split transform flags for the luma and chroma components in accordance with an embodiment of the invention;

FIG. 6A is a flow chart of splitting the residue transform tree for the luma component in accordance with an embodiment of the invention;

FIG. 6B is a flow chart of splitting the residue transform tree for the chroma components in accordance with an embodiment of the invention;

FIG. 7A and FIG. 7B are diagrams illustrating the size of transform units (TUs) in different dimensions in prior techniques;

FIG. 8A is a flow chart of splitting the residue transform tree for the luma component in accordance with the twelfth embodiment of the invention;

FIG. 8B is a flow chart of splitting the residue transform tree for the chroma components in accordance with the twelfth embodiment of the invention; and

FIG. 9 is a block diagram of an apparatus for determining residue transform trees for color components in video coding in accordance with an embodiment of the invention.

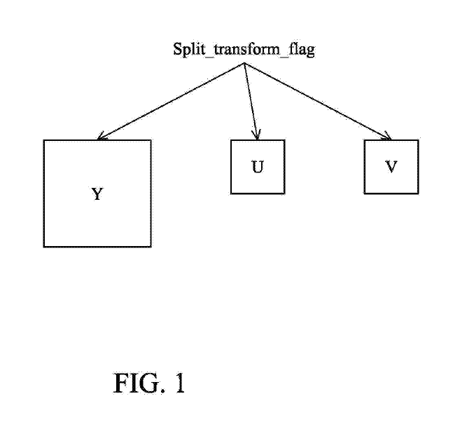

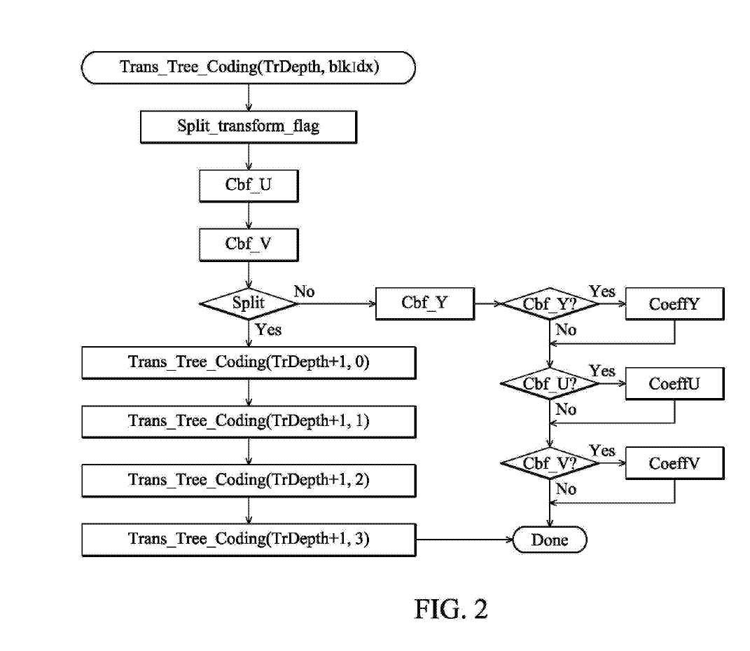

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

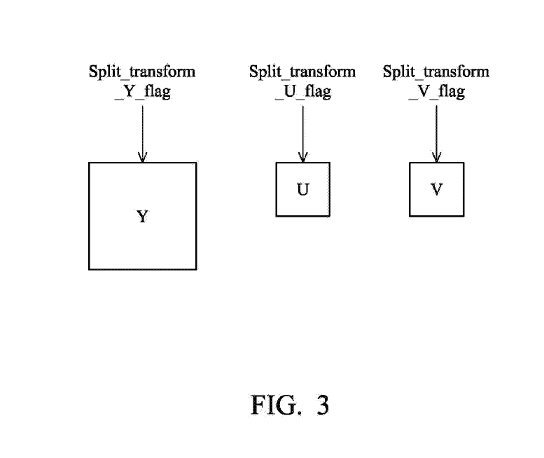

FIG. 3 is a diagram illustrating separate split transform flags for the color components Y, U, and V in accordance with an embodiment of the invention. In the first embodiment, each of the color components Y, U, and V has its own transform tree, and each of the Y, U, and V components has an individual split transform flag to indicate its own transform depth increase. Specifically, an individual split transform flags is used for each of the Y, U, V component rather than using one shared split transform flag for all of is denoted as three separate syntax elements such as split_transform_Y_flag, split_transform_U_flag, and split_transform_V_flag, respectively. For ease of description, the syntax elements split_transform_Y_flag, split_transform_U_flag, and split_transform_V_flag will be used in the following sections to indicate the split transform flags for the Y, U, and V components, respectively. Similarly, the syntax elements split_transform_luma_flag and split_transform_chroma_flag are also used to indicate the split transform flags for the luma and chroma components in the following sections.

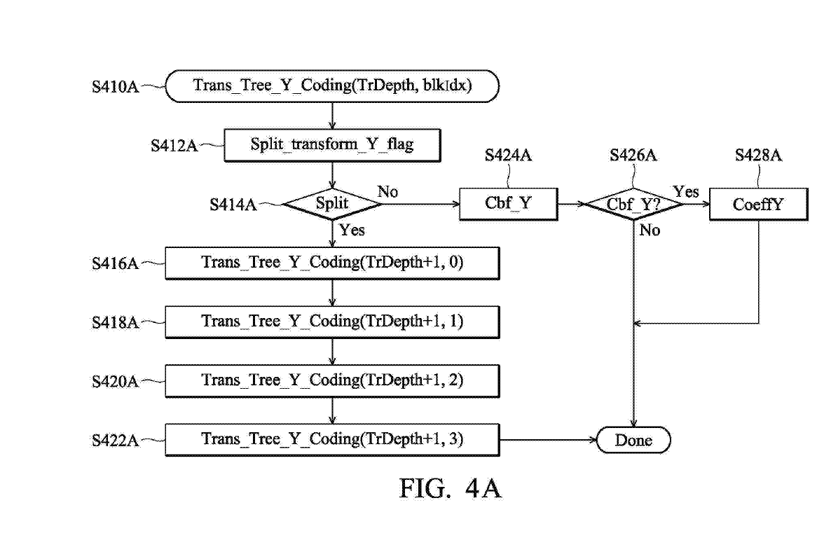

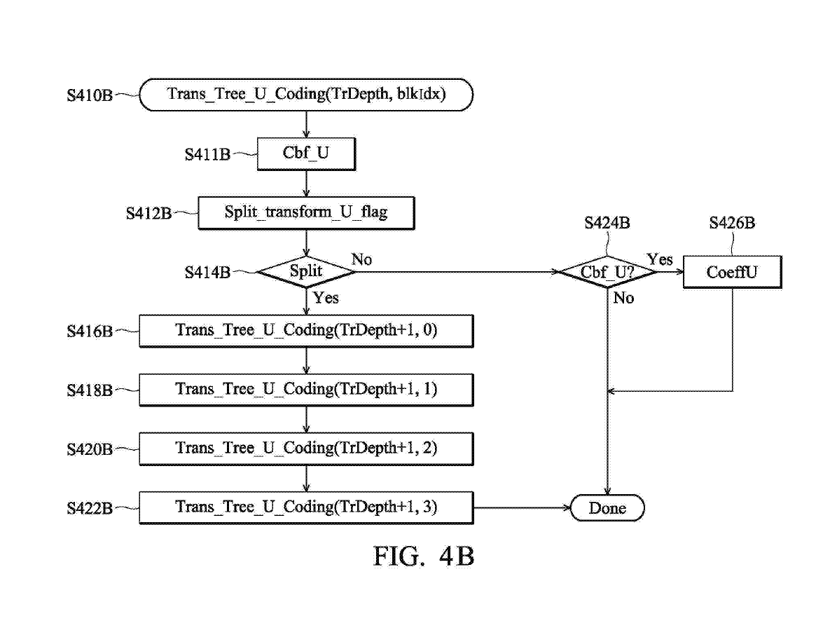

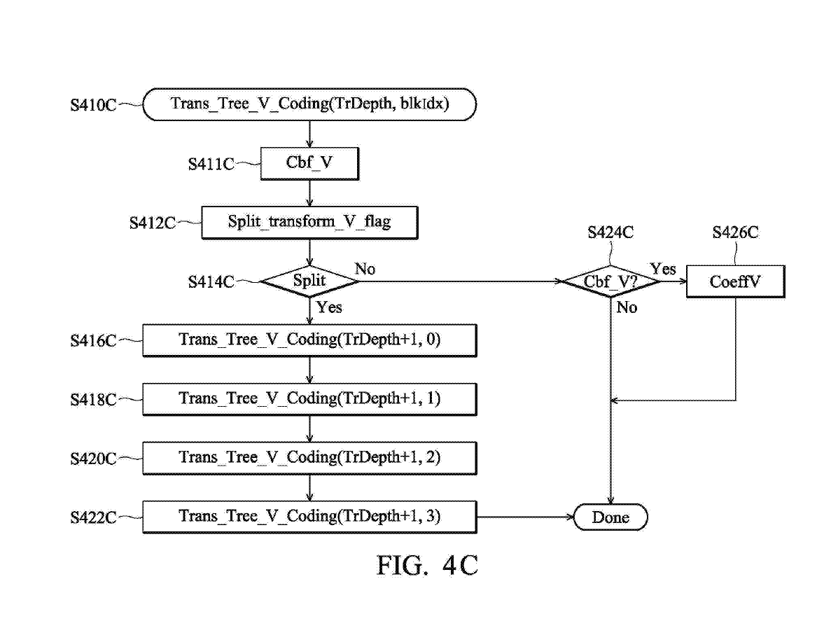

In the second embodiment, the transform tree is signaled separately for each of the color components Y, U, and V. FIG. 4A is a flow chart of splitting the residue transform tree for the Y component in accordance with an embodiment of the invention. In step S410A, the transform function and associated parameters (e.g. the current tree depth TrDepth, and the block index blkIdx) for splitting the transform tree for the Y component are received. In step S412A, the flag split_transform_Y_flag is indicative of whether to split the Y component in the residue transform tree is received, and it is determined whether the flag split_transform_Y_flag is to split the Y component in the residue transform tree (step S414A). If the flag split_transform_Y_flag is indicative of splitting the Y component in the residue transform tree, steps S416A˜S422A are performed to split the current transform unit (current tree node) of the Y component into four sub units (sub nodes) of the next depth level. If the flag split_transform_Y_flag indicates not splitting the Y component in the residue transform tree, the coded block flag for the Y component (hereinafter referred to as “Cbf_Y”) is received (step S424A). In step S426A, it is determined whether the parameter Cbf_Y specifies non-zero transform coefficient for the Y component. If so, the non-zero transform coefficient CoeffY for the Y component is received (step S428A), and the flow ends. Otherwise, the flow ends.

FIG. 4B is a flow chart of splitting the residue transform tree for the U component in accordance with an embodiment of the invention. In step S410B, the transform function and associated parameters (e.g. the current tree depth TrDepth, and the block index blkIdx) for splitting the transform tree for the U component are received. In step S411B, the coded block flag for the U component is received. In step S412B, the flag split_transform_U_flag indicative of whether to split the U component in the residue transform tree is received, and it is determined whether the flag split_transform_U_flag is to split the U component in the residue transform tree (step S414B). If the flag split_transform_U_flag indicates that splitting the U component in the residue transform tree is required, steps S416B˜S422B are performed to split the current transform unit (current tree node) of U component into four sub units (sub nodes). If the flag split_transform_U_flag indicates not splitting the U component in the residue transform tree, the coded block flag for the U component (hereinafter referred to as “Cbf_U”) which specifies a non-zero transform coefficient for the U component (step S424B) is checked. If the Cbf_U is true, the non-zero transform coefficient CoeffU for the U component is received (step S426B), and the flow ends. Otherwise, the flow ends.

FIG. 4C is a flow chart of splitting the residue transform tree for the V component in accordance with an embodiment of the invention. In step S410C, the transform function and associated parameters (e.g. the current tree depth TrDepth, and the block index blkIdx) for splitting the transform tree for the V component are received. In step S411C, the coded block flag for the V component is received. In step S412C, the flag split_transform_V_flag indicative of whether to split the V component in the residue transform tree is received, and it is determined whether the flag split_transform_V_flag is to split the V component in the residue transform tree (step S414C). If the flag split_transform_V_flag indicates that splitting the V component in the residue transform tree is required, steps S416C˜S422C are performed to split the current transform unit (current tree node) into four sub units (sub nodes). If the flag split_transform_V_flag indicates not splitting the V component in the residue transform tree, the coded block flag for the V component (hereinafter referred to as “Cbf_V”) which specifies a non-zero transform coefficient for the V component (step S424C) is checked. If the Cbf_V is true, the non-zero transform coefficient CoeffV for the V component is received (step S426C), and the flow ends. Otherwise, the flow ends. It should be noted that the flows shown in FIG. 4B and FIG. 4C are similar to that in FIG. 4A, and each of the color components Y, U, and V has its own transform tree.

In the third embodiment, the transform tree syntaxes for U and V components are signaled prior to that for the Y component. For example, the order for signaling the transform tree syntaxes for the color components may be U, V and Y, or V, U and Y.

In the fourth embodiment, in the transform tree for Y component, the split transform flag split_transform_Y_flag is signaled in each tree node, and the parameter Cbf_Y is only signaled in the leaf tree node (or leaf transform unit).

In the fifth embodiment, in the transform tree for U component, the split transform flag split_transform_U_flag is signaled after the parameter cbf_U is signaled in each tree node. In addition, in the transform tree for V component, the split transform flag split_transform_V_flag is also signaled after the parameter cbf_V is signaled in each tree node. Furthermore, for each inter-coded CU of U or V component, if the parameter Cbf is signaled as zero, the associated transform_split_flag is not signaled.

In the sixth embodiment, six separate sequence parameter set (SPS) raw byte sequence payload (RBSP) syntax to define the max transform hierarchy depth level is assigned to each of the Y, U, and V components in the inter-coding cases and intra-coding cases. Specifically, for the inter-coding cases, three separate syntax elements max_transform_hierarchy_depth_Y_inter, max_transform_hierarchy_depth_U_inter, max_transform_hierarchy_depth_V_inter instead of one shared syntax element max_transform_hierarchy_depth_inter, are used to indicate the maximum transform depth in a sequence for Y, U, and V components, respectively. For the intra-coding cases, three separate syntax elements max_transform_hierarchy_depth_Y_intra, max_transform_hierarchy_depth_U_intra, max_transform_hierarchy_depth_V_intra instead of one shared syntax element max_transform_hierarchy_depth_intra, are used to indicate the maximum transform depth in a sequence for Y, U, and V components, respectively. Accordingly, the max transform hierarchy depth level for the Y, U, V components in the inter-coding mode and the intra-coding mode can be defined separately.

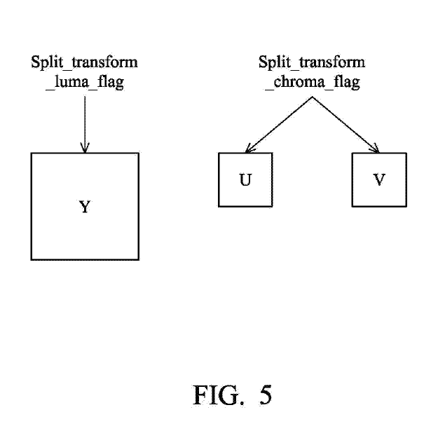

FIG. 5 is a diagram illustrating separate split transform flags for the luma and chroma components in accordance with an embodiment of the invention. In the seventh embodiment, two separate syntax elements split_transform_luma_flag and split_transform_chroma_flag are used to indicate the transform depth increase for the luma (Y) and chroma (U and V) components, respectively.

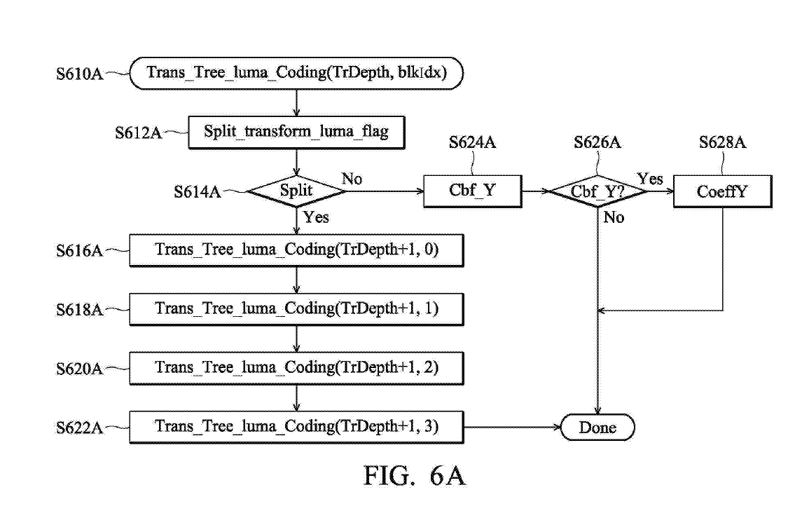

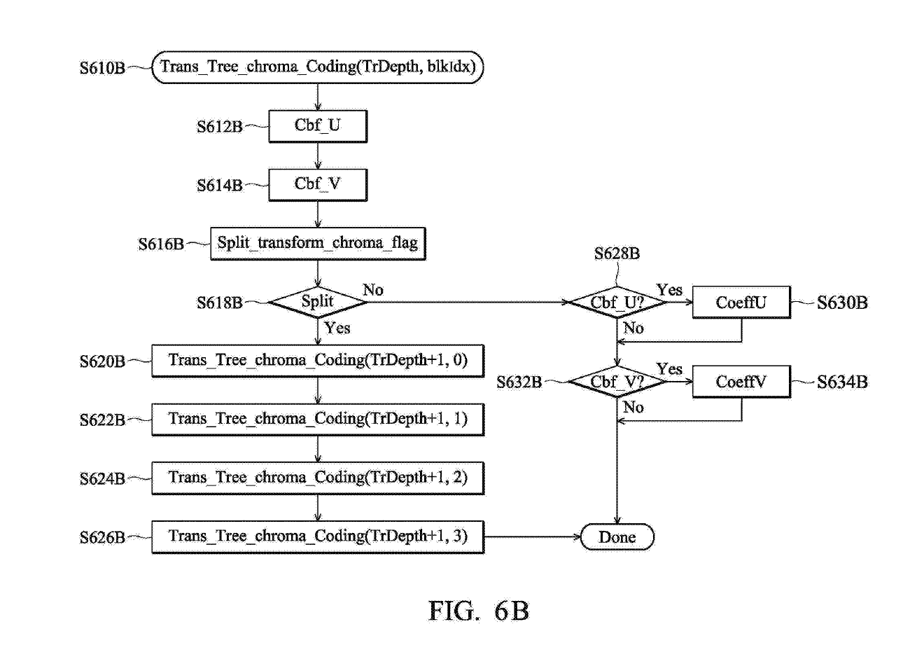

In the eighth embodiment, the transform trees for luma and chroma components are signaled separately. FIG. 6A is a flow chart of splitting the residue transform tree for the luma components in accordance with an embodiment of the invention. In step S610A, the transform function Trans_Tree_luma_Coding and associated parameters (e.g. the current tree depth TrDepth, and the block index blkIdx) for splitting the transform tree for the luma component are received. In step S612A, the flag split_transform_luma_flag indicative of whether to split the luma component in the residue transform tree is received, and it is determined whether the flag split_transform_luma_flag is to split the luma component in the residue transform tree (step S614A). If the flag split_transform_luma_flag is indicative of splitting the Y component in the residue transform tree, steps S616A˜S622A are performed to split the current transform unit (tree node) of the Y component into four sub units (sub nodes) of the next depth level. If the flag split_transform_luma_flag indicates not splitting the Y component in the residue transform tree, the parameter Cbf_Y for the luma component is received (step S624A). In step S626A, it is determined whether the parameter Cbf_Y specifies non-zero transform coefficient for the luma component. If so, the non-zero transform coefficient CoeffY for the luma component is received (step S628A), and the flow ends. Otherwise, the flow ends.

FIG. 6B is a flow chart of splitting the residue transform tree for the chroma components in accordance with an embodiment of the invention. In step S610B, the transform function Trans_Tree_chroma_Coding and associated parameters (e.g. the current tree depth TrDepth, and the block index blkIdx) for splitting the transform tree for the chroma component are received. In step S612B, the coded block flag Cbf_U for the U component is received. In step S614B, the coded block flag Cbf_V for the V component is received. In step S616B, the flag split_transform_chroma_flag indicative of whether to split the chroma component in the residue transform tree is received, and it is determined whether the flag split_transform_chroma_flag is to split the chroma component in the residue transform tree (step S618B). If the flag split_transform_chroma_flag is indicative of splitting the chroma component in the residue transform tree, steps S620B˜S626B are performed to split the current transform unit (current tree node) of the chroma component (both U and V components) into four sub units (sub nodes) of the next depth level. If the flag split_transform_chroma_flag indicates not splitting the chroma component in the residue transform tree, it is determined whether the coded block flag Cbf_U specifies non-zero transform coefficient for the U component (step S628B). If so, the non-zero transform coefficient CoeffU for the U component is received (step S630B). Otherwise, step S632B is performed. In step S632B, it is determined whether the coded block flag Cbf_V specifies non-zero transform coefficient for the V component. If so, the non-zero transform coefficient CoeffV for the V component is received (step S634B). Otherwise, the flow ends.

It should be noted that the parameters Cbf_U and Cbf_V for the chroma component are always signaled before the split transform flag for the chroma component in the eighth embodiment. However, the coded block flag Cbf_luma for the luma component is always signaled after determining not to split the transform tree. In other words, the split transform flag is signaled in each tree node for the luma component, and the associated parameter Cbf_luma is only signaled in the leaf tree node. For the chroma component, the split transform flag is signaled after signaling the parameters Cbf_U and Cbf_V in each TU level. In addition, for each inter-coded CU, if the parameters Cbf_U and Cbf_V are both signaled as zero, the split transform flag is not signaled since it is always determined not to split the transform tree in this situation (i.e. “No” in step 618B). Furthermore, in the ninth embodiment, the transform tree for the chroma component is signaled before the transform tree for the luma component.

In the tenth embodiment, an individual sequence parameter set (SPS) raw byte sequence payload (RBSP) syntax to define the max transform hierarchy depth level is assigned to the luma and chroma components in the inter-coding mode and intra-coding mode. Specifically, for the inter-coding mode, the syntax elements max_transform_hierarchy_depth_luma_inter, and max_transform_hierarchy_depth_chroma_inter are assigned to the luma and chroma components, respectively. For the intra-coding mode, the syntax elements max_transform_hierarchy_depth_luma_intra, and max_transform_hierarchy_depth_chroma_intra are assigned to the luma and chroma components, respectively. Accordingly, the max transform hierarchy depth level for the luma and chroma components in the inter-coding mode and the intra-coding mode can be defined separately.

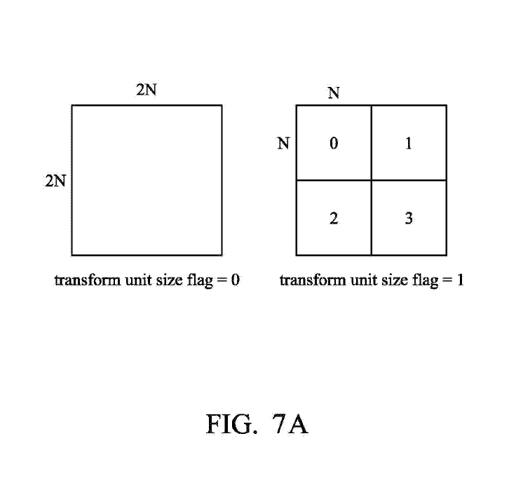

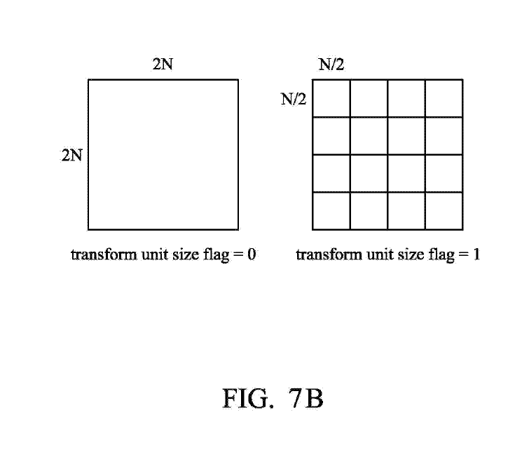

FIG. 7A and FIG. 7B are diagrams illustrating the size of transform units (TUs) size for TUs in different dimensions in prior techniques. For example, when the size of the CU is 2N×2N, 2N×N, N×2N, or N×N, the size of the TU is 2N×2N when the transform unit size flag is 0, and the size of the TU is N×N when the transform unit size flag is 1, as shown in FIG. 7A. When the size of the CU is 2N×nU, 2N×nD, nL×2N, and nR×N, the size of the TU is 2N×2N when the transform unit size flag is 0, and the size of the TU is N/2×N/2 when the transform unit size flag is 1, as shown in FIG. 7B.

Specifically, when splitting each CU into TUs, a two-level TU structure is used, and only two TU options are allowed for each CU (2N×2N). The selection of the TU size is signaled by the transform unit size flag. If the transform unit size flag is 0, the TU size is 2N×2N. If the transform unit size flag is 1, the TU size is N×N when the splitting of PUs is symmetric, and the TU size is N/2×N/2 when the splitting of PUs is asymmetric.

It is observed that in YUV (or YCbCr, or Y′CbCr, or some other luma-chroma) video contents, the residual planes of chroma components are more homogenous than that of the luma component. Therefore, a bigger transform block (TB) size might benefit the coding performance of chroma more than luma.

In the eleventh embodiment, the transform block sizes of the selected luma and chroma components for a given coding block (CB) are derived by one flag (e.g. split_transform_flag). However, the derived values may be the same or different. For example, the dimension of the size of the chroma transform block (TB) of a given chroma CB can be expressed using the following equations:

r_w=w_luma_cb/w_luma_tb; (1)

r_h=h_luma_cb/h_luma_tb; (2)

w_chroma_tb=(w_chroma_cb/r_w)<<1; (3)

h_chroma_tb=(h_chroma_cb/r_h)<<1; (4)

where w_luma_cb and w_luma_tb denote the width of the given luma CB and the luma TB, respectively; r_w denotes the ratio between the width of the given luma CB and that of the luma TB; h_luma_cb and h_luma_tb denote the height of the given luma CB and the luma TB, respectively; r_h denotes the ratio between the height of the given luma CB and that of the luma TB; w_chroma_tb denotes the width of the chroma TB; w_chroma_cb denotes the width of the given chroma CB; h_chroma_tb denotes the height of the chroma TB; and h_chroma_cb denotes the height of the given chroma CB. Specifically, the splitting depth of the transform tree for the chroma component is less than that for the luma component by 1, as shown in equations (3) and (4).

Similar to the luma transform block size being capped by the luma coding block size, the chroma transform block size is capped by the chroma coding block size. That is, the chroma transform block cannot exceed the chroma coding block that it is in. At the same time, the chroma transform block size as well as the luma transform block size is capped by the maximum and minimum transform block size constrained by high level configurations. In the twelfth embodiment, the selected luma and chroma transform block sizes for a given CB are associated and signaled together. They can both be derived by one flag, although the derived values may be the same or different.

Alternatively, the splitting depth of the transform tree for the chroma component may vary depending on an adjustable parameter “a”, as shown in the following equations (5) and (6):

w_chroma_tb=(w_chroma_cb/r_w)<<a; (5)

h_chroma_tb=(h_chroma_cb/r_h)<<a; (6)

It should be noted that the parameter “a” can be signaled in a higher level syntax (e.g. higher than the CU level) where the parameter “a) can be any non-negative integer number such as 0, 1, 2, . . . , etc., which can be either fixed length coded or variable length coded, and appear in SPS, PPS, slice header, CTU header (under context of HEVC) or introduced to a region or partial picture such as a group of LCUs, or a tile, etc. An example of parameter “a” (e.g. the flag “log2_diff_luma_chroma_transform_block_size”) in SPS is shown in Table 1, which can be applied to PPS, slice header, etc.

TABLE 1

| | Descriptor |
|---|---|
| seq_parameter_set_rbsp( ) { | |
| ...... | |
| log2_min_transform_block_size_minus2 | ue(v) |
| log2_diff_max_min_transform_block_size | ue(v) |
| max_transform_hierarchy_depth_inter | ue(v) |
| max_transform_hierarchy_depth_intra | ue(v) |
| log2_diff_luma_chroma_transform_block_size | ue(v) |
| ...... | |
| } | |

One example of variable length coding of parameter “a” or flag “log2_diff_luma_chroma_transform_block_size” is shown in Table 2.

TABLE 2

| log2_diff_luma_chroma_transform_block_size | bin |
|---|---|
| 1 | 1 |
| 0 | 01 |
| 2 | 00 |

Alternatively, the TU size of the chroma component can be implicitly inferred in the TU size of the luma component, and the signaling of the flag indicative of the TU size for the chroma component can be omitted. However, in some embodiments, the PU for the luma component may be zero, and the flag indicative of the TU size for the chroma component is explicitly signaled.

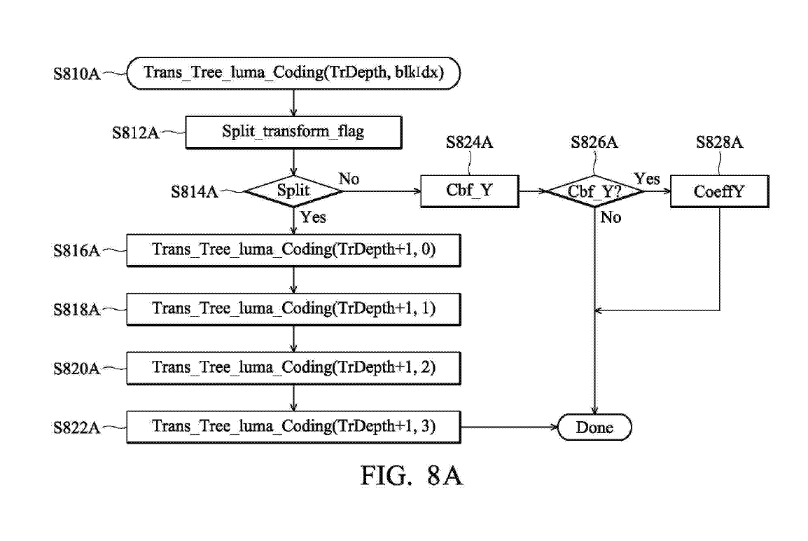

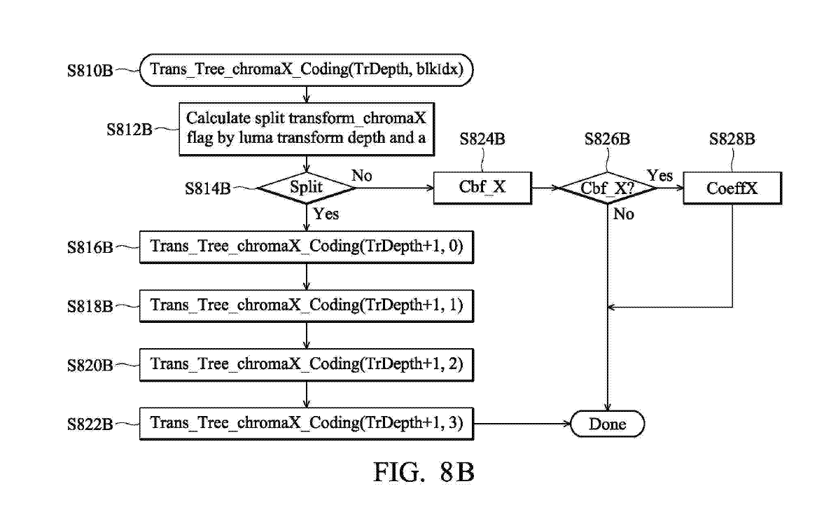

FIG. 8A is a flow chart of splitting the residue transform tree for the luma components in accordance with the twelfth embodiment of the invention. In step S810A, the transform function Trans_Tree_luma_Coding and associated parameters (e.g. the current transform depth TrDepth, and the block index blkIdx) for splitting the transform tree for the luma component are received. In step S812A, the flag split_transform_flag indicative of whether to split the luma component in the residue transform tree is received, and it is determined whether the flag split_transform_flag is to split the luma component in the residue transform tree (step S814A). If the flag split_transform_flag is indicative of splitting the luma component in the residue transform tree, steps S816A˜S822A are performed to split the current transform unit (current tree node) of the luma component into four sub units (sub nodes) of the next depth level. If the flag split_transform_flag indicates not splitting the luma component in the residue transform tree, the parameter Cbf_Y for the Y component is received (step S824A). In step S826A, it is determined whether the parameter Cbf_Y specifies non-zero transform coefficient for the Y component. If so, the non-zero transform coefficient CoeffY for the Y component is received (step S828A), and the flow ends. Otherwise, the flow ends.

FIG. 8B is a flow chart of splitting the residue transform tree for the chroma components in accordance with the twelfth embodiment of the invention. In step S810B, the transform function Trans_Tree_chromaX_Coding and associated parameters (e.g. the current transform depth TrDepth, and the block index blkIdx) for splitting the transform tree for the chroma component are received. It should be noted that the aforementioned chromaX component denotes the subcomponent of the chroma component (e.g., the U or V component). In step S812B, the split transform flag for the chromaX component is calculated according to the luma transform depth (shown in FIG. 8A) and the parameter “a”. Specifically, the splitting depth of the transform tree for the chromaX component is less than that for the luma component by “a”, as described above (e.g. equations (5) and (6)).

In step S814B, it is determined whether the split_transform_chromaX_flag is to split the residue transform tree of chromaX component. If the flag split_transform_chromaX_flag indicates splitting the chromaX component in the residue transform tree, the chromaX component is also splitted in the residue transform tree as well, and steps S816B˜S822B are performed to split the current transform unit (current tree node) of the chromaX component into four sub units (sub nodes) of the next depth level. If the flag split_transform_chromaX_flag indicates not splitting the chromaX component in the residue transform tree, the chromaX component is not split in the residue transform tree, and the parameter Cbf_X for the chromaX component is received (step S824B). In step S826B, it is determined whether the parameter Cbf_X specifies non-zero transform coefficient for the chromaX component. If so, the non-zero transform coefficient CoeffX for the chromaX component is received (step S828B), and the flow ends. Otherwise, the flow ends.

In the twelfth embodiment, a two-level transform block structure for a given CB is used, and one of two different transform block sizes is selected to perform the transform for a given CB. Specifically, a flag is used to determine whether the bigger TB size is selected or the smaller transform block size is selected.

Table 3 depicts possible TU sizes for different symmetric PU sizes in accordance with an embodiment.

TABLE 3

| PU size | Bigger TU size | Smaller TU size |
|---|---|---|
| 2N × 2N | 2N × 2N | N × N |
| 2N × N/N × 2N | N × N | (N/2) × (N/2) |
| N × N | N × N | (N/2) × (N/2) |

As shown in Table 3, when the PU size is 2N×2N, the bigger TU size is 2N×2N, and the smaller TU size is N×N. When the PU size is 2N/N or N×2N, the bigger TU size is N×N, and the smaller TU size is (N/2)×(N/2). When the PU size is N×N, the bigger TU size is N×N, and the smaller TU size is (N/2)×(N/2). Specifically, the bigger TU size is the maximum square that does not cross boundaries of the given PU, and the smaller TU size is the bigger TU size divided by 2 (i.e. half size) in both vertical and horizontal dimensions.

Table 4 depicts possible TU sizes for different asymmetric PU sizes in accordance with an embodiment.

TABLE 4

| PU size | Bigger TU size | Smaller TU size |
|---|---|---|
| 2N × (N/2), 2N × (3N/2) | N × N | (N/2) × (N/2) |
| (N/2) × 2N, (3N/2) × 2N | N × N | (N/2) × (N/2) |
| 2N × (N/4), 2N × (7N/4) | (N/2) × (N/2) | (N/4) × (N/4) |
| (N/4) × 2N, (7N/4) × 2N | (N/2) × (N/2) | (N/4) × (N/4) |

As shown in Table 4, when the PU size is 2N×(N/2) or 2N×(3N/2), the bigger TU size is N×N, and the smaller TU size is (N/2)×(N/2). When the PU size is (N/2)×2N or (3N/2)×2N, the bigger TU size is N×N, and the smaller TU size is (N/2)×(N/2). When the PU size is 2N×(N/4) or 2N×(7N/4), the bigger TU size is (N/2)×(N/2), and the smaller TU size is (N/4)×(N/4). When the PU size is (N/4)×2N or (7N/4)×2N, the bigger TU size is (N/2)×(N/2), and the smaller TU size is (N/4)×(N/4). Specifically, the smaller TU size is the maximum square that does not cross boundary of the given PU, and the bigger TU size is 2 times (i.e. double) the smaller TU size in both vertical and horizontal dimensions.

Table 5 depicts possible TU sizes for different PU sizes using non-square transforms in accordance with an embodiment.

TABLE 5

| PU size | Bigger TU size | Smaller TU size |
|---|---|---|
| 2N × N | 2N × N or 2N × (N/2) | N × (N/2) or N × (N/4) |
| N × 2N | N × 2N or (N/2) × 2N | (N/2) × N or (N/4) × N |
| 2N × (N/2), 2N × (3N/2) | 2N × (N/2) | N × (N/4) |
| (N/2) × 2N, (3N/2) × 2N | (N/2) × 2N | (N/4) × N |

As shown in Table 5, when the PU size is 2N×N, the bigger TU size is 2N×N or 2N×(N/2), and the smaller TU size is N×(N/2) or N×(N/4). When the PU size is N×2N, the bigger TU size is N×2N or (N/2)×2N, and the smaller TU size is (N/2)×N or (N/4)×N. When the PU size is 2N×(N/2) or 2N×(3N/4), the bigger TU size is 2N×(N/2), and the smaller TU size is N×(N/4). When the PU size is (N/2)×2N or (3N/4)×2N, the bigger TU size is (N/2)×2N, and the smaller TU size is (N/4)×N.

It should be noted that both the luma TU size and the chroma TU size can be determined based on Table 3, Table 4, and Table 5 in the thirteenth embodiment.

In the thirteenth embodiment, the transform block sizes of the selected luma and chroma components for a given CB are derived by different flags.

In the fourteenth embodiment, the luma TU size is determined based on Table 3, Table 4, and Table 5, and the chroma TU size is determined using the method (e.g. equations (1), (2), (5), (6)) described in the twelfth embodiment.

In the fifteenth embodiment, the variable parameter “a” in equations (5) and (6) can be different for square TBs and non-square TBs.

In the sixteenth embodiment, for video content with 4K and above resolution, only unit-directional inter-prediction is allowed for 8×8 inter-prediction blocks. In other words, the smallest inter-prediction block size is limited to 8×8 for 4K and above video contents.

The methods described above can be used in a video encoder as well as in a video decoder. Embodiments of the methods according to the present invention as described above may be implemented in various hardware, software codes, or a combination of both. For example, an embodiment of the present invention can be a circuit integrated into a video compression chip or program codes integrated into video compression software to perform the processing described herein.

It should be noted that, for ease of description, the YUV color space is used in the aforementioned embodiments, and each color component in the YUV color space has an individual transform depth increase. One having ordinary skill in the art will appreciate that the invention is not limited to the YUV color space, and other existing color spaces (e.g. Y′UV, YCbCr, YPbPr, etc.) having similar properties or any other color spaces to be later developed can be used in the invention. In other words, at least two color components in a given color space may have an individual transform depth increase. Additionally, when the color components in a given color space is classified into two categories, the methods described in the aforementioned embodiments can be applied, and each categories has an individual transform depth increase.

Furthermore, regarding the embodiments using the luma and chroma components, the luma component and the chroma component can be replaced with a first-type color component and a second-type color component. For one having ordinary skill in the art, it will be appreciated that the invention is not limited to the luma component and the chroma component, and any color space having at least two types of color components can be used in the invention.

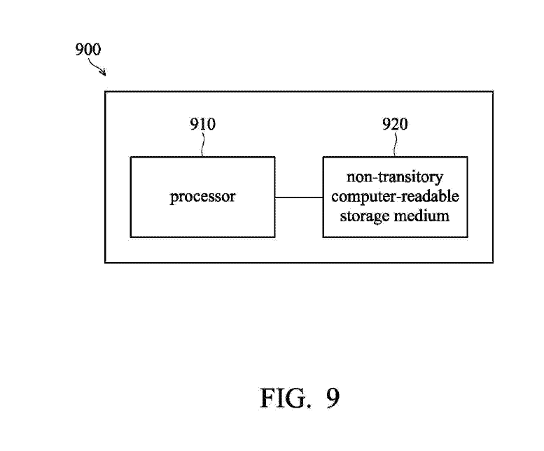

FIG. 9 is a block diagram of an apparatus for determining residue transform depth for color components in a video sequence in accordance with an embodiment of the invention. The apparatus 900 comprises one or more processors 910 and a non-transitory computer-readable storage medium 920. The non-transitory computer-readable storage medium 920 records computer-readable software code or firmware code that defines the particular methods embodied by the invention such as from the first embodiment to the seventeenth embodiment. The one or more processors units 910 may be a computer processor, a digital signal processor, a microprocessor, or a field programmable gate array (FPGA). The software code or firmware codes may be developed in different programming languages and different format or style. The software codes may also be compiled for different target platform. However, different code formats, styles and languages of software codes and other means of configuring code to perform the tasks in accordance with the invention will not depart from the spirit and scope of the invention.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method for determining residue transform tree for color components in a video sequence, comprising:
determining an individual transform depth increase for each color component; and
determining a transform tree for each color component according to the individual transform depth increase associated with each color component.

2. The method as claimed in claim 1, wherein the color components comprise a first color component, a second color component and a third color component, and a split transform flag of the first color component, a split transform flag of the second color component, and a split transform flag of the third color component are used to indicate the transform depth increase for the first, second and third color components, respectively.

3. The method as claimed in claim 2, wherein the transform trees in a coding unit (CU) level are signaled for the first, second, and third color components, respectively.

4. The method as claimed in claim 3, wherein a signaling order for the three transform trees is the second, third, and first color component, or the third, second, and first color component.

5. The method as claimed in claim 3, wherein the split transform flag of the first color component is signaled at each tree node in the transform tree for the first color component to indicate whether splitting the tree node into more than one sub nodes, and a coded block flag (Cbf) for the first color component is signaled at a leaf tree node to indicate whether a transform unit (TU) for the first color component has non-zero coefficients or not.

6. The method as claimed in claim 3, wherein a coded block flag for the second color component is signaled at each tree node in the transform tree for the second color component to indicate whether a block indicated by the tree node for the second color component has non-zero coefficients or not, and the split transform flag of the second color component is signaled after the coded block flag for the second color component to indicate whether to split the tree node for the second color component or not.

7. The method as claimed in claim 6, wherein the split transform flag of the second color component is not signaled when the coded block flag for the second color component is equal to 0 for an inter-coded CU.

8. The method as claimed in claim 3, wherein a coded block flag for the third color component is signaled at each tree node in the transform tree for the third color component to indicate whether a block indicated by the tree node for the third color component has non-zero coefficients or not, and the split transform flag of the third color component is signaled after the coded block flag for the third color component to indicate whether to split the tree node for the third color component or not.

9. The method as claimed in claim 8, wherein the split transform flag of the third color component is not signaled when the coded block flag for the third color component is equal to 0 for an inter-coded CU.

10. The method as claimed in claim 1, wherein the color components comprise a first type color components and a second type color component, and a split transform flag of the first type color component and a split transform flag of the second type color component are used to indicate the transform depth increase for the first and second type color components, respectively

11. The method as claimed in claim 10, wherein the transform trees for the first and second type color components are signaled separately in a coding unit (CU) level.

12. The method as claimed in claim 11, wherein a signaling order for the transforms trees of the first and second type color components is the second type color component first, and then the first type color component.

13. The method as claimed in claim 11, wherein the split transform flag of the first type color component is signaled at each tree node in the transform tree for the first type color component to indicate whether to split the tree node for the first type color component or not, and a coded block flag for the first type color component is signaled at a leaf tree node to indicate whether a TU for the first type color component has non-zero coefficients.

14. The method as claimed in claim 11, wherein a coded block flag of a first subcomponent of the second type color component and a coded block flag of a second subcomponent of the second type color component are signaled at each tree node in the transform trees for the second type color component to indicate whether the tree node for the first subcomponent and the tree node for the second subcomponent have non-zero coefficients, and the split transform flag of the second type color component is signaled after the coded block flags of the first subcomponent and the second subcomponent to indicate whether to split a TU for the second type color component or not.

15. The method as claimed in claim 14, wherein the split transform flag of the second type color component is not signaled when the coded block flags of the first subcomponent and the second subcomponent are both equal to 0 for an inter-coded CU.

16. The method as claimed in claim 1, wherein a plurality of syntax elements for indicating a maximum transform depth of each of the color components coded by a prediction mode are incorporated in sequence level, picture level, or slice level.

17. The method as claimed in claim 1, wherein the color components comprise a first type color component and a second type color component, and a transform block (TB) size for a given coding block (CB) of the first type color component is defined by a split transform flag.

18. The method as claimed in claim 17, wherein a transform block size for a given coding block (CB) of the second type color component is determined according to one or combination of a size of the given CB of the first type color component, the transform block size for the given CB of the first type color component, and a size of the given CB of the second type color component.

19.-27. (canceled)

28. An apparatus for determining residue transform depth for color components in a video sequence, comprising:
one or more computer processors; and
a non-transitory computer-readable storage medium comprising instructions, that when executed by the one or more computer processors, control the one or more computer processors to be configured for:
determining an individual transform depth increase for each color component; and
determining a transform tree for each color component according to the individual transform depth increase associated with each color component.
